(19) United States
(12) Patent Application Publication
(10) Pub. No.: US 2003/0155413 A1
(43) Pub. Date: Aug. 21, 2003

(54) System and method for authoring and providing information relevant to a physical world

(76) Inventors: Rozsa Kovesdi, Madison, NJ (US); Ajit Rajasekharan, East Brunswick, NJ (US)

Correspondence Address: PENNIE AND EDMONDS, 1155 AVENUE OF THE AMERICAS, NEW YORK, NY, 100362711

(21) Appl. No.: 10/035,952

(22) Filed: Dec. 26, 2001

Related U.S. Application Data
(60) Provisional application No. 60/306,356, filed on Jul. 18, 2001.

(51) Int. Cl. G06F 17/00

(52) U.S. Cl. 235/375

(57) ABSTRACT

A system and method capable of reading machine-readable labels from physical objects, reading coordinate labels of geographical locations, reading timestamp labels from an internal clock, accepting digital text string labels as input obtained directly from a keyboard type input device, or indirectly using a speech-to-text engine, and treating these different labels uniformly as object identifiers for performing various indexing operations such as content authoring, playback, annotation and feedback. The system further allows for the aggregating of object identifiers and their associated content into a single addressable unit called a tour. The system can function in an authoring and a playback mode. The authoring mode permits new audio/text/graphics/video messages to be recorded and bound to an object identifier. The playback mode triggers playback of the recorded messages when the object identifier accessed. In the authoring mode, the system supports content authoring that can be done coincident with object identifier creation thereby enabling authored content to be unambiguously bound to the object identifier. In the playback mode, the system can be programmed to accept/solicit annotations/feedback from a user which may also be recorded and unambiguously bound to the object identifier.

### CROSS REFERENCE TO RELATED APPLICATION

This application claims the benefit of U.S. Provisional Patent Application Serial No. 60/306,356, filed on Jul. 18, 2001, which is incorporated herein by reference in its entirety.

### BACKGROUND OF THE INVENTION

This invention relates generally to information systems and, more particularly, relates to a system and method for authoring and providing information relevant to a physical world.

The exponential growth of the Internet has been driven by three factors, namely, the ability to author content easily for this new medium, the simple text-string (URL) based indexing scheme for content organization, and the ease of accessing authored content (e.g., by just a mouse click on a hyperlink). However, attempts made to emulate the success of the Internet in the mobile device usage space have not been very successful to date. The mobile device usage space is the whole physical world we live in and, unlike the tethered PC-based Internet world where all objects are virtual, the physical world is composed of real objects, geographical locations, and temporal events (which occur in isolation or in conjunction with an object or location). These diversities pose problems not present in the existing Internet world where all virtual objects can be uniformly addressed by a URL. Thus, there exists a need for a scheme that addresses the labeling of objects, locations and temporal events, a scheme that has an indexing method which treats these different labels uniformly and transparently to the underlying labeling method, a scheme that can help author content seamlessly for these different physical world entities and bind the content to the indices, and a scheme that can provide easy access and playback of the authored content for any real-world entity, e.g., object, location and temporal events.

Attempts have been made to build applications that enable seamless browsing of just one domain, such as the domain of physical objects or the domain of geographical locations. There have also been attempts to treat browsing of objects and locations together. However, these attempts fail to address the key factors mentioned above that made the Internet what it is today, i.e., the most effective medium for information dissemination. In particular, these attempts do not address the labeling issue, which is a problem unique to the physical world and not present in the PC-based virtual browsing method (all content in the virtual world can be addressed by a URL), they do not have a uniform indexing scheme across different labeling schemes, they do not support authoring of content that is bound to these different label types, they do not support content authoring on the device (which is a key deficiency given that on-device content authoring is the most natural, efficient, and error-free method for most mobile device usage scenarios), and they do not support playback of content indexed by the different labeling schemes.

To enable seamless mobile browsing which envelops all of these apparently disparate application domains these deficiencies need to be addressed. The absence of a labeling and content binding scheme makes it very hard for one to do custom labeling of objects and bind content to the labels (the solution offered by presently known systems would be a manual error-prone process). The absence of an annotation/feedback binding scheme makes it very hard to maintain the correspondence between the content and the annotation/feedback. The absence of seamless bridging of location-based, object-based, events-based, conventional web hyperlink based services requires different devices/applications to navigate these different domains.

Currently, there are four separate application domains in the mobile device space, namely, object-based devices and applications, coordinate-based devices and applications, timestamp based devices and applications, and traditional URL-based devices and applications. Object-based devices can read labels off of physical objects (e.g. barcodes and RFID and IR tags) and are typically used in a proactive fashion where a user scans the object of interest using the devices. These devices attempt to support browsing the world of physical objects in a manner that is similar to surfing the Internet using a web browser. The coordinate-based application domain is an emerging domain capitalizing on the knowledge of geographical location made available through a variety of location detection schemes such as GPS, A-GPS, AOA, TDOA etc. An existing application domain in the PC-world, e.g., timeline based information presentation, is also making inroads into the mobile device space. However, no devices or applications presently exist that are capable of bridging these different application domains in a near seamless and transparent manner.

In the field of portable interactive digital information systems that employ device-readable object or location identifiers several systems are known. For example, U.S. Pat. No. 6,122,520 describes a location information system which uses a positioning system, such as the Navstar Global positioning system, in combination with a distributed network. The system receives a coordinate entry from the GPS device and the coordinate is transmitted to the distributed network for retrieval of the corresponding location specific information. Barcodes, labels, infrared beacons and other labeling systems may also be used in addition to the GPS system to supply location identification information. This system does not, however, address key issues characteristic of the physical world such as custom labeling, label type normalization, and uniform label indexing. Furthermore, this system does not contemplate a tour like paradigm. i.e., a “tour” as media content grouped into a logical aggregate.

U.S. Pat. No. 5,938,721 describes a task description database accessible to a mobile computer system where the tasks are indexed by a location coordinate. This system has a notion of coordinate-based labeling, coordinate-based content authoring, and coordinate triggered content playback. The drawback of the system is that it imposes constraints on the capabilities of the device used to playback the content. Accordingly, the system is deficient in that it fails to permit content to be authored and bound to multiple label types or support the notion of a tour.

U.S. Pat. No. 6,169,498 describes a system where location-specific messages are stored in a portable device. Each message has a corresponding device-readable identifier at a particular geographic location inside a facility. The advantage of this system is that the user gets random access to location specific information. The disadvantage of the system is that it does not provide information in greater granularity about individual objects at a location. The smallest unit is a ‘site’ (a specific area of a facility). Another disadvantage of the system is that the user of the portable device is passive and can only select among pre-existing identifier codes and messages. The user cannot actively create identifiers nor can he/she create or annotate associated messages. The system also fails to address the need for organizing objects into meaningful collections. Yet another disadvantage is that the system is targeted for use within indoor facilities and does not address outdoor locations.

U.S. Pat. No. 5,796,351 describes a system for providing information about exhibition objects. The system employs wireless terminals that read identification codes from target exhibition objects. The identification codes are used, in turn, to search information about the object in a data base system. The information on the object is displayed on a portable wireless terminal to the user. Although the described system does use unique identification code assigned to objects and a wireless local area network, the resulting system is a closed system: all devices, objects, portable terminals, host computers, and the information content are controlled by the facility and operational only inside the boundaries of the facility.

U.S. Pat. No. 6,089,943 describes a soft toy carrying a barcode scanner for scanning a number of barcodes each individually associated with a visual message in a book. A decoder and audio apparatus in the toy generate an audio message corresponding to the visual message in the book associated with the scanned barcode. One of the biggest drawbacks of this system is the inability to author content on the apparatus itself. This makes it cumbersome for one who creates content to author it for the apparatus, i.e., one has to resort to a separate means for authoring content. It also makes it harder to maintain and keep track of the association with the authored content, object identifiers and the physical object.

U.S. Pat. No. 5,480,306 describes a language learning apparatus and method utilizing optical identifier as an input medium. The system requires an off-the-shelf scanner to be used in conjunction with an optical code interpreter and playback apparatus. It also requires one to choose a specific barcode and define an assignment between words and sentences to individual values of the chosen code. The disadvantages of this system are the requirement for two separate apparatus making it quite unwieldy for several usage scenarios and the cumbersome assignment that needs to be done between digital codes and alphabets and words.

U.S. Pat. No. 5,314,336 describes a toy and method providing audio output representative of a message optically sensed by the toy. This apparatus suffers from the same drawbacks as some of the above-noted patents, in particular, the content authoring deficiency.

U.S. Pat. No. 4,375,058 describes a apparatus for reading a printed code and for converting this code into an audio signal. The key drawback of this system is that it does not support playback of recorded audio. It also suffers from the same drawbacks as some of the above-noted patents.

U.S. Pat. No. 6,091,816 describes a method and apparatus for indicating the time and location at which audio signals are received by a user-carried audio-only recording apparatus by using GPS to determine the position at which a particular recording is made. The intent of this system is to use the position purely as a means to know where the recording was done as opposed to using the binding for subsequent playback on the apparatus or for feedback or annotation binding. Also, the timestamp usage in the system fails to contemplate using a timestamp as a trigger for playback of special temporal events or binding a timestamp to objects, coordinates and labels.

In addition to the patents listed above, there are numerous other systems on the market whose common objective is to link printed physical world information to a virtual Internet URL. More specifically, these systems encode URLs into proprietary barcodes. The user scans the barcode in a catalog and her web browser is launched to the given URL. Examples of companies who use this approach are AirClic (http://www.airclic.com), GoCode (http://www.gocode.com), and Digital:Convergence (http://www.digitalconvergence.com). The advantage of these systems is that they link the physical world to the rich information source of the Internet. The disadvantages of these systems are that the URL is directly encoded in the barcode and cannot be modified and there is a one-to-one mapping between a physical object and digital URL information. BarPoint, Inc. (http://www.barpoint.com) provides a system that uses standard UPC barcode scanning for product lookup and price comparison on the Internet. The advantage of the BarPoint system is that it does not require a proprietary scanner device and there is an indirection when mapping code to information instead of hard-coded, direct URL links. Nevertheless, all of the above systems disadvantageously treat each object, i.e., each barcode, as an individual item and do not provide a means to create logical relationships among the plurality of physical objects at the same location. Another disadvantage of these systems is that they do not enable the user to create a personalized version of the information or to give feedback.

### SUMMARY OF THE INVENTION

To address the needs and overcome the deficiencies described above, the present invention is embodied in a system and method for authoring and providing information relevant to a physical world. Generally, the system utilizes a hand-held device capable of reading one or more labels such as, for example, a barcode, a RFID tag, IR beacon, location coordinates, and a timestamp, and for authoring and playing back media content relevant to the labels. In the authoring mode, labels representing objects, locations, temporal events, text strings, etc. are identified and translated into object identifiers which are then bound to media content that the author records for that object identifier. Media content can be grouped into a logical aggregate called a tour. A tour can be thought of as an aggregation of multimedia digital content, indexed by object identifiers. In the playback mode, the authored content is played when one of the above mentioned labels (barcode, RFID tag, location coordinates, etc.) is read and whose generated object identifier matches one of the identifiers stored earlier in a tour. The system also enables audio/text/graphics/video annotation to be recorded and bound to the accessed object identifier. Binding to the accessed object identifier is also done for any audio/text/graphics/video feedback provided by the user on the object.

A better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the invention, reference may be had to preferred embodiments shown in the following drawings in which:

FIG. 1 illustrates an embodiment of the present invention in the context of a tour of a shopping center;

FIG. 2 illustrates a block diagram of an exemplary computer network architecture for supporting tour applications;

FIG. 3a illustrates an exemplary tree structure for an instance of a tour;

FIG. 3b illustrates exemplary file formats supported by a tour;

FIG. 4 illustrates examples of bindings that may occur during the labeling, authoring, playback, annotation and feedback stages of a tour;

FIG. 5a illustrates various label input schemes, label encoding, and label normalization process and their implementation within a tour;

FIG. 5b illustrates various proactive label detection schemes and an implicit system driven label detection scheme;

FIG. 6 illustrates a process-oriented view of a tour including pre-tour and post-tour processing;

FIG. 7 illustrates an exemplary method used for pre-tour authoring;

FIG. 8a illustrates an exemplary method used for tour playback;

FIG. 8b illustrates an exemplary method for tour playback specifically using a networked remote server site;

FIG. 9 illustrates an embodiment of the present invention in the context of a guided tour of a cemetery;

FIG. 10 illustrates a block diagram of exemplary internal components of a hand-held mobile device for use within the network illustrated in FIG. 2;

FIG. 11 illustrates an exemplary physical embodiment of a hand-held mobile device; and

FIG. 12 illustrates a further exemplary embodiment of a hand-held mobile device.

### DETAILED DESCRIPTION

Turning now to the figures, wherein like reference numerals refer to like elements, there is illustrated a comprehensive system and method for authoring and providing information to users about a physical world. In this regard, the system and method generally provide information by interacting with labels, such as machine-readable labels on physical objects, coordinate labels of geographical locations, timestamp labels from an internal clock, etc., which labels are treated uniformly as object identifiers. The object identifiers are more specifically used within the system, in a manner to be described in greater detail hereinafter, to perform various indexing operations such as, for example, content authoring, playback, annotation, and feedback. The system is also capable of aggregating object identifiers and their associated content into a single addressable unit referred to hereinafter as a “tour.”

To provide a comprehensive system and method for providing information to users about a physical world, and to allow users to record their own impressions of the physical world, the system preferably functions in two modes, namely, an authoring mode and a playback mode. The authoring mode permits new media content, e.g., audio, text, graphics, digital photographs, video, etc., to be recorded and bound to an object identifier. In the authoring mode, the system supports content authoring that can be done coincident with object identifier creation thereby enabling authored media content to be unambiguously bound to an object identifier. This solves the problem of maintaining correspondence between physical object/location/timestamp labels and media content. The playback mode triggers playback of media when an object identifier is accessed. In the playback mode, the system can also be programmed to accept/solicit annotations/feedback from a user which can be recorded and further unambiguously bound to an object identifier. Annotation and feedback are both user responses to objects seen. The difference is fairly small in that the user owns the annotations while feedback is typically owned by the person who solicited the feedback. Also, feedback could be interactive such as a user responding to a sequence of questions.

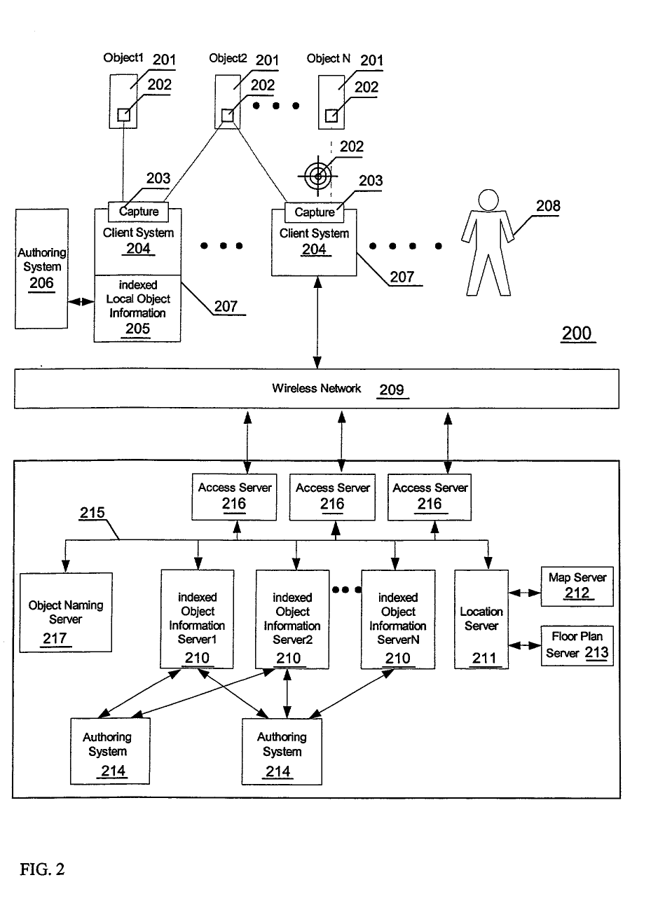

Turning now to FIG. 2, FIG. 2 and the following description are intended to provide a brief, general description of a suitable computing environment in which the invention may be implemented. Although not required, the invention will be described in the general context of computer-executable instructions being executed by computing devices. The computer-executable instructions may include routines, programs, objects, components, data structures, or the like that perform particular tasks or implement data types. The portable computing devices 207 operated by mobile users may include hand-held devices, voice or voice/data enabled cellular phones, smart-phones, notebooks, tablets, wearable computers, personal digital assistants (PDAs) with or without a wireless network interface, purpose built devices, etc. The invention may also be practiced in distributed computing environments where tasks are performed by computing devices that are linked through a communications network and where computer-executable instructions may be located in both local and remote memory storage devices. The remote computer system may include servers, minicomputers, mainframe computers, storage servers, database servers, etc.

More specifically, FIG. 2 illustrates a network architecture 200 in which a tour server side is coupled to a client side via a wireless distribution network 209. While the wireless distribution network 209 is preferably a voice/data cellular telephone network, it will be apparent to those of ordinary skill in the art that other forms of networking may also be used. For example, the network can use other forms of wireless transmission such as RF, 802.11, Bluetooth, etc. in a Wireless Local Area Network (WLAN) or Personal Local Area Network (WPAN), etc.

Connected to the wireless distribution network 209 on the client side of the network 200 are one or more mobile users 208 which can roam indoor and/or outdoor locations to thereby move among a plurality of objects 201 in the physical world. As will be described in greater detail below, the locations and/or objects 201 in the physical world can be represented by machine readable object identifiers, such as, barcode labels, RFID tags, IR tags, Blue tags (Bluetooth readable tags), location coordinates (“labels-in-the-air”) or timestamps. In this regard, timestamps can serve as labels on their own right or can be considered to be qualifiers to the media content bound to an object or a place. By way of example, media content qualified by a timestamp would be information pertaining to a mountain resort location where Winter information could be different from Summer information.

Location coordinates (latitude, longitude, and optionally altitude) may be determined by a location determination unit coupled with the mobile device using signals transmitted by GPS satellites or other sources. Alternatively, the location coordinates can be provided at a server, and any mobile device requiring such data can address the location data request to a networked remote location server. This is especially useful when the mobile device does not have location identification capability, or in indoor facilities where GPS satellite signals are obscured. The location of a mobile device connected to an indoor WLAN access point can be approximated by the location server connected to the WLAN, by considering known location(s) of wireless access point(s), the signal strength detected between mobile device and access point(s), and possible using additional spatial information about the geometry of the enclosing building space.

To read information from the object identifiers, each mobile user 208 is equipped with a personal mobile device 207 having capture circuitry 203 that is adapted to respond to the labels. The capture circuitry can be a barcode reader, RFID reader, IR port, Bluetooth receiver, GPS receiver, audio receiver, touch-tone keypad, etc. In the networked environment, the personal mobile device 207 can run a thin client system 204 with input and output capabilities while storage and computational processing takes place on the server side of the network. The client system may include a wireless browser software application such as a WAP browser, Microsoft Mobile Explorer, etc. and support communication protocols with the server well known in the arts such as WAP, HTTP, etc. In non-networked applications, the personal mobile device 207 can contain additional local indexed storage 205 in addition to the client system 204 whereby all processing can take place within the personal mobile device 207.

In a networked environment, a tour may be transported between a remote server both by a wired connection or a wireless connection. In the wired case, the tour and associated data transfer may be done directly by a modem connection between the device and a remote server or indirectly using a host computer as an intermediary. Examples of transferring a tour from a mobile device to a host computer via wired connection are described in greater details below. In the wireless case, specifically in the case of the tour application being used on a phone, the application may run both remotely in the context of a VoiceXML browser or locally on the device.

In the remote server playback case, the connection between the server and the phone need not be held for the duration of the entire tour. The server could maintain the state of the of the last rendered position in the tour across multiple connections permitting the connection to be re-established on a need basis. The state maintenance not only avoids the user having to log back in with a username/password, but puts the user right back to where he was in the tour, like a CD remembering the last played track. The server can use the caller's phone number to identify the last tour the user was in. In certain scenarios where the caller's phone number cannot be identified, a user would be prompted for a usemame and password and would be immediately taken to the last tour context. This functionality not only saves on the connection time costs, but also is effective for certain applications such as a tour implemented for providing driving directions using VoiceXML.

For tour authoring and publishing purposes the mobile device 207 might have a USB connector so that the mobile device and can be directly connected to a host computer. For personal mobile devices 207 that do not have a communication link, such as an USB connector, a scheme for tour retrieval (i.e., uploading the tour to a host computer) can be implemented using a headphone output. Though this scheme results in some audio quality degradation in the re-recording process, it would serve as a safe-backup of valuable content on a PC. When sequential playback is initiated in a particular device mode, called “Upload Playback mode,” the index values of a tour are sent as specialized tones whose frequencies are chosen so to not collide with human speech. The output of the headphones is connected to the microphone input of a PC. Special software running on the PC recognizes the alphanumeric index delimiters between content and regenerates a tour. The alphanumeric indices values could represent normalized label values such as timestamps, barcode values, or coordinates.

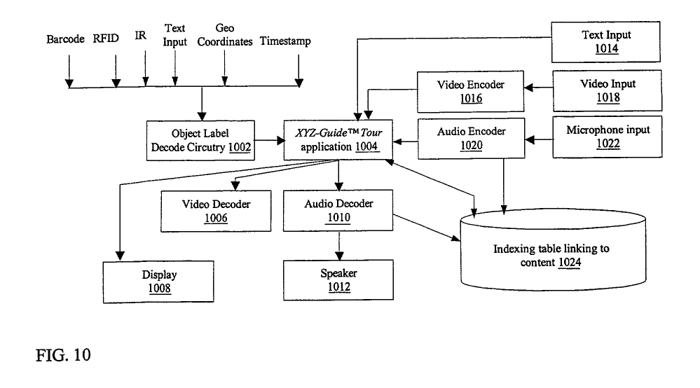

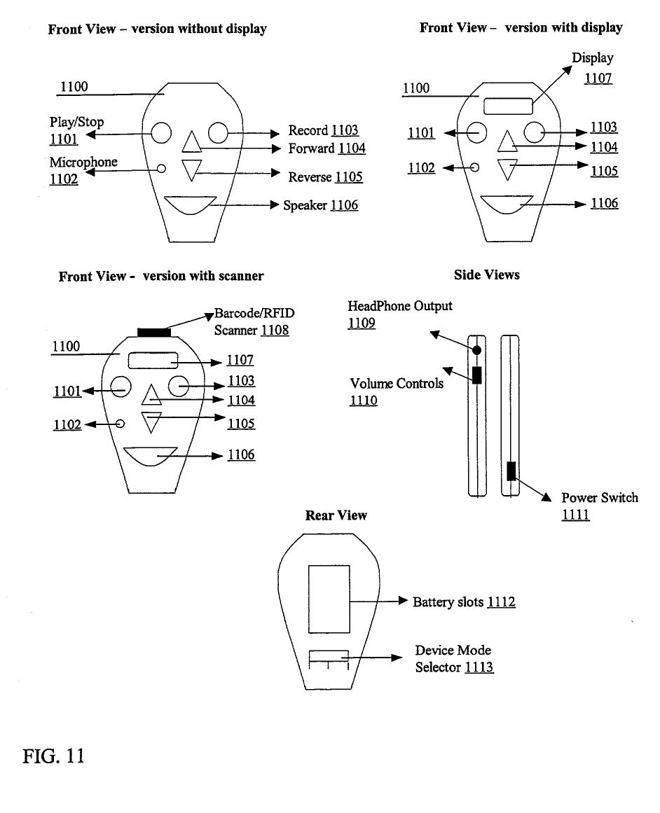

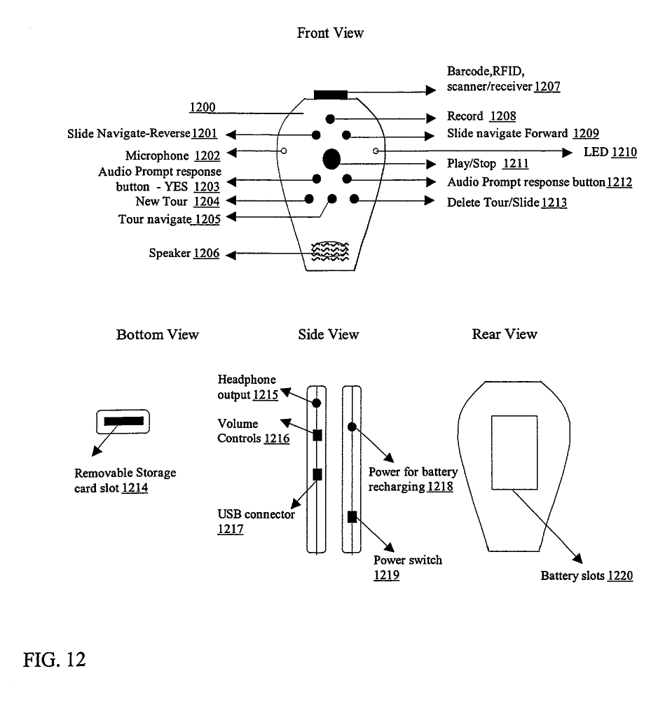

To provide for the authoring and/or playback of media content related to a tour, a personal mobile device 207, examples of which are illustrated in FIGS. 10-12, preferably includes object label decode circuitry 1002 that is adapted to read/respond to barcode information, RFID information, IR information, text input, speech to text input, geographic coordinate information, and/or timestamp information. The object label decode circuitry 1002 provides input to a tour application 1004 resident on the personal mobile device 207. The tour application, which will be described in greater detail below, generally responds to the input to initiate the authoring or rendering of media content as a function of the object label read. For playing the media content, the personal mobile device 207 may include one or more of a video decoder 1006 associated with a display 1008 and an audio decoder 1010 associated with a speaker 1012. Display 1008 may be a visual display such as liquid crystal display screen. The device may function without a display.

For inputting information which may be bound to an object identifier, the personal mobile device 207 may also include means for inputting textual information (e.g., a keyboard 1014), pointing device such as pen, touch sensitive screen which is part of the display, video information (e.g., a video encoder 1016 and video input 1018), and/or audio information (e.g., an audio encoder 1020 and microphone 1022), touch-tone buttons (DTMF) for phones. Various control keys such as, for example, play, record, reverse, fast forward, volume control, etc. can be provided for use in interacting with media content. In this manner, the various control keys can be used to selectively disable device functionality in certain device modes, particularly playback mode, using hardware button shields, device mode selectors, or embedded software logic.

The mobile personal device 207 can be implemented on any computing device, ranging from a personal computer, notebook, tablet, PDA, phone, to a purpose-built device. Since the tour application does not mandate the implementation of all object identification schemes, a mobile personal device 207 may implement label identification schemes most suited for the device capabilities and usage context. Also, a mobile personal device 207 may only support the authoring and/or rendering of particular media. For those mobile devices 207 that do not have the resources (e.g., a resource-constrained phone) to support the full capabilities of the tour application, a tour application proxy could be built for the device, and the resource intensive processing can take place on the server side.

Turning to the tour application, the tour application 1004 preferably includes executable instructions that can create and modify a tour tree structure (discussed in greater detail below) for performing various tree operations such as tree traversal, tree node creation, tree node deletions, and tree node modifications. The tour application 1004 also supports the authoring, the playback, annotation, and/or feedback of a tour. The tour application 1004 may also support format transformations of a tour. It will be understood that the tour application 1004 can work in connection with a proxy to perform these functions. Still further, the tour application 1004 can be a stand alone module or integrated with other modules such as, by way of example only, a navigation system or a remote database. In this latter instance, while the navigation system would provide the details of how to get from point A to point B, the tour application 1004 could provide information pertaining to locations and objects found along the path from point A to point B.

At the server side of the network 200, the server side is preferably implemented as a computer system which is connected to the wireless network 209 by one or more access servers 216. The access servers 216 may be a WAP gateway, voice portal, HTTP server, SMSC (Short Message Service Center) or the like. Additionally found on the server side is an object information server 219, an optional object naming server 209, and an optional location server 211. The object information servers 210 contain an indexed collection of multimedia content, which may reside on one or more external databases (not illustrated). The object naming server 209 acts as a master indexer for the object information servers 210 and can be used to speed up access to data. The location server 211 can be used to compute the location of a mobile personal device 207 based on data received from the wireless network 209 or from outside sources. The location server 211 can further work in connection with a map server 212 and with a floor plan server 213 wherein the floor plan server 213 can be a digital repository of building layout data. The server side may also include an authoring system which can be used to add, delete, and/or modify media content stored in the information servers. It will be appreciated that the various computers that can be used within the server side of the network may themselves be connected to one another via a local area network.

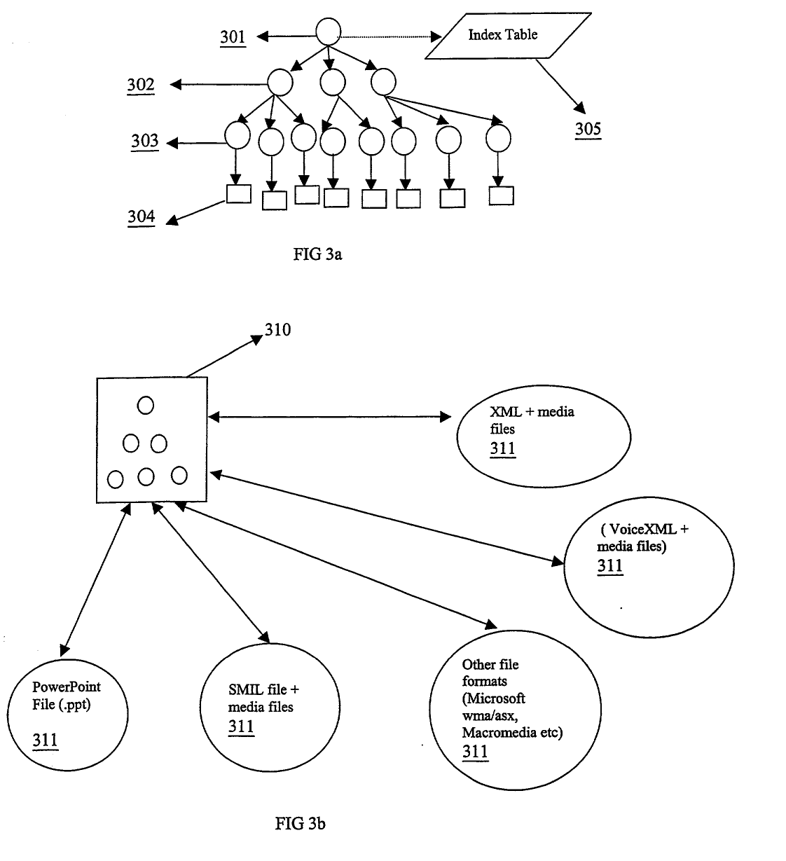

To provide information to a user via a mobile personal device, and as noted previously, the system may use the concept of a “tour” which can be considered to be an ordered list of slides that are indexed by object identifiers created from text strings, physical object labels, coordinates of geographical locations, and timestamps representing temporal events. In this regard, a slide is an ordered list of media content which can optionally contain annotations and feedback. Annotations and feedback are also lists of media content. Media content can further be considered to be an ordered list of digital content in text, audio, graphics, and/or video stored in various persistent formats 311 such as, by way of example only, XML, PowerPoint, SMIL, etc. as illustrated in FIG. 3b. The slides in a tour may be optionally aggregated into nodes called channels.

In one embodiment the tour is implemented as a multimedia digital information library, where the multimedia content is indexed by normalized labels (i.e., object identifiers). The digital information includes audio files, visual image files, text files, video files, multimedia files, XML files, SMIL files, hyperlink references, live agent connection links, programming code files, configuration information files, or a combination thereof. Various transformations can be performed on the multi-media content. Example of a transformation is when recorded audio is transcribed into a text file. The advantage of content format transformations is to allow accessing the same tour with mobile devices of different capabilities and according to user preference. An example of this is accessing a tour using a voice only cellular phone or accessing the same tour with a PDA with display capabilities.

The aggregation of media content can be done to any depth as deemed appropriate to the application context. This is particularly illustrated in FIG. 3a which depicts an exemplary instance of a tour in the form of a tree structure. The nodes of the tree are the tour node 301, the channel node 302, the slide node 303, the media node, 304. In the example shown, an index table 305 is associated with the tour tree.

Index tables 305 are particularly used to gain access to the media content associated with a tour. In this regard, an indexing operation, performed in response to the reading of an object identifier, can result in a tour, slide, or channel being rendered on a mobile personal device 207. As noted previously, the tour, slide, or channel can be provided to the mobile personal device 207 from the server side of the network and/or from local memory, including local memory expansion slots

The nodes of the tour hierarchy can contain information appropriate to a given application which can use a logical structuring of information without regard to file format specifications or physical locations of the files. Accordingly, there may be several physical file implementations of a tour and, so long as the structural integrity of the tour is preserved in a particular implementation, transformations can be done between different file formats. However, it is cautioned that, during a transformation, some media content types may be inappropriate/lost since the destination mobile personal device 207 may not support some or all of the media content in a tour. For example, a mobile personal device 207 with no display would be limited to presenting tour media content that is in an audio format.

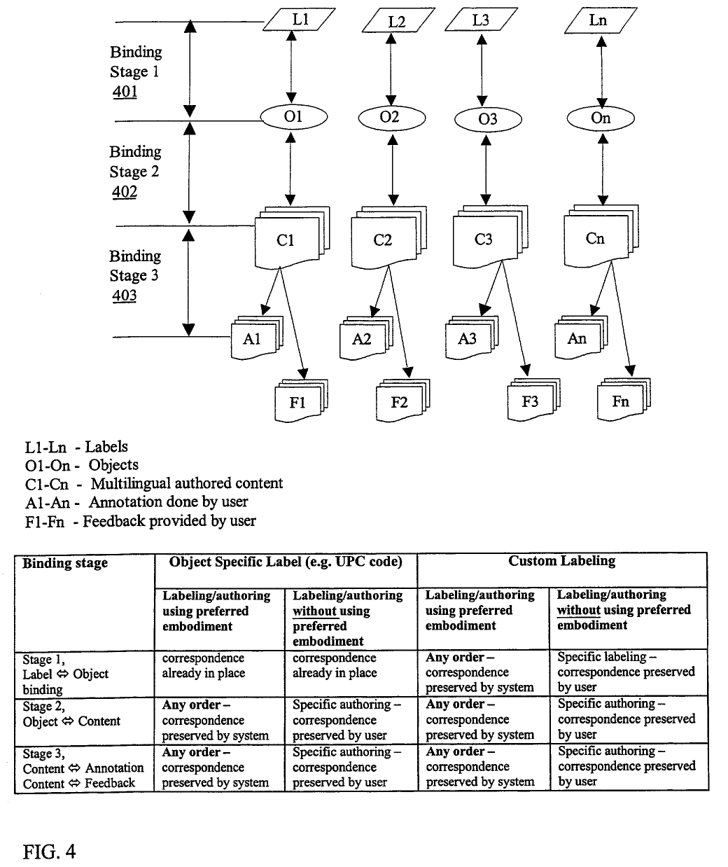

To author a tour containing information about physical objects, locations, and/or temporal events (i.e., entities) in the physical world, the entities are labeled which labels are treated uniformly as object identifiers. The object identifiers are stored within the system and media content for an entity is bound to its corresponding object identifier. When assigning labels to objects, generally illustrated at stage 401 in FIG. 4, objects that do not have a preexisting label are provided with a customized label. Objects with preexisting labels can include items that have UPC coded tags. Example of custom labeling would be labeling of a picture in a photo album or a paragraph in a book. It will be appreciated that, even for objects that have preexisting labels, custom labeling may be done in certain circumstances. The remaining stages illustrated in FIG. 4 include stage 402 where objects/object identifiers are bound to media content and stage 403 where optional feedback and annotations can be bound to objects/object identifiers.

To label geographical location, the concept of a “label-in-the-air” is introduced. In an authoring mode, an authoring device, such as a personal mobile device 207, determines its current location coordinates using a GPS or similar technology, or using information available from the wireless network. The computer coordinates may then be used as the object identifier for the geographic location. The author may bind media content to a “label-in-the-air” the same way as any other label. Furthermore, the usage of coordinate data does not require the exact coordinate to be available to initiate playback of the media content bound to the “label-in-the-air.” Rather, a circular shell of influence may be defined around the coordinate that can trigger playback of the media content. For simplicity of authoring, it is preferred that the shell of influence be a planar projection of the coordinate thereby eliminating the need to consider altitude variations.

It will be further appreciated that various concentric circular shells of influence may be defined around a coordinate label which shells of influence can be bound to unique media content. In this manner, entry into these various shells can trigger audio and/or visual content authored explicitly for that shell. This can be particularly useful in gaming applications such as, for example, a treasure hunt. An example is using color as an indicator of distance from the labeled object is to display “cold” blue on the mobile device when the treasure hunter is far away from the object and gradually turn the display “warm” red (as getting closer) to “red hot” when the treasure hunter reaches the object.

Temporal events require no further labeling, i.e., the timestamp can serve as the label. In this regard, timestamps can be used to label both periodic and aperiodic temporal events. Furthermore, even when labeling aperiodic events, timestamp labels can have an artificial periodicity associated with them to serve as a reminder of past events. An internal clock within a personal mobile device 207 can be used to check the validity of timestamp labels which, when read and if valid, can initiate content rendering in playback mode. When using timestamps to label aperiodic events, the timestamps are used as secondary labels to a primary label such as a physical object label or location coordinate. Such labels are thus identified as a consequence of identifying the primary label.

Text strings can directly serve as labels for indexing media content. It is possible that the text string was the output of a speech recognizer. By way of further example, an instance of a tour can be a hierarchical set of markup language, e.g., XML or HTML pages combined with one or more index tables. With the addition of index tables and ordering of the pages, an existing web site could be implemented as a tour where all indexing is done using text strings.

The labeling scheme for physical objects could range from manually writing down a code on an object to tagging the object with a barcode, RFID tag or IR tag. For scenarios that need custom labeling, the labeling can be done in any order regardless of the labeling scheme being used. This eliminates the need to maintain an extraneous order between labels and objects which, in turn, eliminates errors in the labeling process.

The data structure representation for a normalized label could be a variable length null-terminated string. When a barcode label is scanned, the scanning device returns the label in a device specific manner, which is then transformed by the normalization process into a null terminated string. For example if the value encoded on the barcode label was the UPC code of a product “Altoids” brand peppermint candies, after the normalization it would become a string of the form “05928000200.” Note that the normalized string value does not reveal any information about how the value was retrieved—it strips out all information about the label retrieving process. These normalized strings, also referred to as object identifiers, are then used as indices for organizing authored content.

During content authoring, since labels are normalized into object identifiers, multiple labeling schemes may be used to access the same piece of media content, provided the data encoded by these labeling schemes yield the same value after normalization. For example, an object can be labeled by associating a UPC text stream therewith and media content bound to the object can be retrieved by entering the same UPC text stream or by scanning a UPC bar code corresponding to the UPC text stream. In a further example, a coordinate obtained from a GPS type device may be embedded into a barcode label, an RFID tag, or even etched into an object. Thus, in playback mode, described below, a personal mobile device 207 with any one of the label detection capabilities, e.g., barcode reader, RFID tag reader, IR port, digital text or speech to text capabilities, can be used to retrieve media content bound to the object identifier corresponding to the object since, in this case, the information that is embedded into the different labels is a normalized form of label data, namely, the coordinate. For multiple labeling schemes to index the same object the data in multiple labels should be such that they all result in the same normalized value. In the above example, the barcode label, and the RIFD tag, embed the same value—location coordinates.

Just as multiple labeling schemes result in the same normalized index value (referred to as the object identifier), multiple distinct object identifiers can refer to the same object. An example can illustrate the difference between multiple labeling schemes used to yield the same object identifier, and multiple distinct object identifiers indexing the same object. Consider a street with and embedded RFID tag. The coordinate values returned by a GPS device could be embedded into the RFID tag. Content could be authored for the normalized value—the coordinate. A user may also create a text-string label for that street name and bind the normalized version of that label to the same content. When a user of the tour comes to that location, he could access the content using either a GPS device or a RFID reader. Alternatively, he may read the street name and enter the street name to access the same content. In this case, the GPS and RFID labeling scheme yield the same normalized index value. The text string labeling results in a different labeling value that indexes the same content.

Further, if the device only has location determination capability and text input mechanism, the location of the user could be used to narrow down the object identifier search space. This would be a very nice functionality from a user experience standpoint since it can be used for automatically listing all objects in the proximity of the user. In those scenarios where there are a large number of objects, the culled search space could help the user by auto-completion of the street name as he types it in (in the case of the device with keyboard input scheme), or unambiguously recognize the street name (in the case of the device with speech recognition capability) vocalized by the user. In this scenario, two object identifiers are used in both authoring and playback. In the playback mode, one of the object identifiers (location coordinates) is used to aid the detection of the other (the street name text string).

A special case of multiple labeling methods being used to refer to the same media content is the functionality to index any tour with an ordinal index value of the content, the implicit ordering of content present in a tour. This ordering provides an alternate way to get to authored content regardless of its normalized labeling method. This is a special case because the normalized label is a digital text string representing the ordinal index of the content which may not be the same as the normalized index type explicitly used during authoring. For example, content authored with coordinates being used as the normalized value can be retrieved using the ordinal index value for that content.

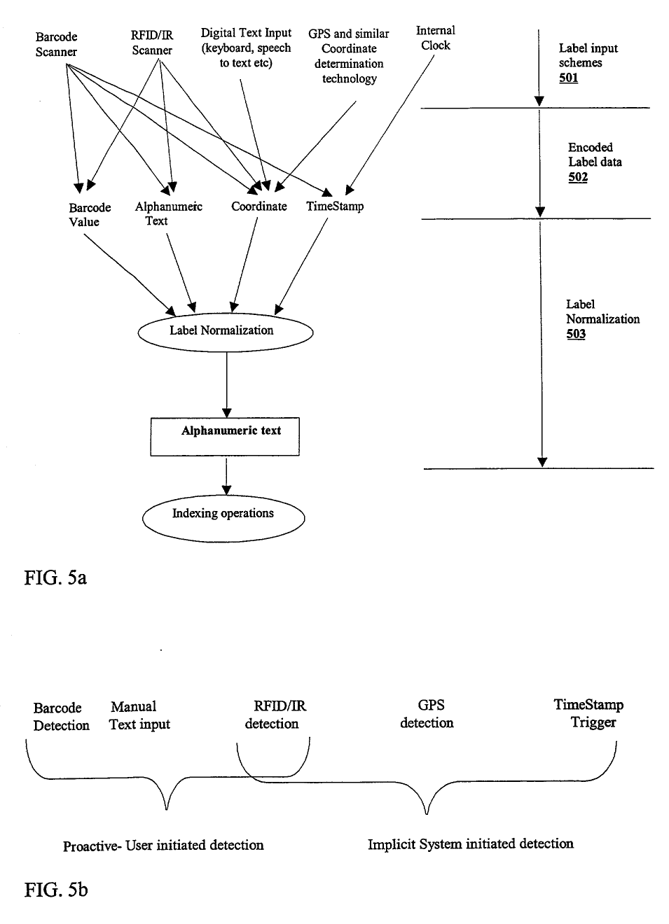

To access and/or author media content, a label identification process is performed as illustrated in FIG. 5. The outcome of the label identification process is an object identifier that can be used for indexing. As illustrated, the object identifier is independent of the label type. Furthermore, as noted above, different kinds of data 502 can be embedded in different types of labels 501 and the normalization process 503 yields a normalized index value.

In the authoring mode, the identification of the labels is done proactively by the user either manually or with the aide of an apparatus, such as a bar code scanner, optical scanner, location coordinate detector, and/or a clock. An object identifier can be used to generically represent one or more of these identified labels. Specifically, an object identifier can be used as a normalized representation of different labels and, thereby, can serve the key purpose of allowing different labels to uniformly index media content in a manner that is transparent to their underlying differences. Furthermore, as noted previously, since labels are treated in a normalized manner, it is possible for label detection to be performed differently during the authoring and playback operations.

To maintain the association between an object identifier and media content for an object, an indexed database is created during the authoring mode of operation. When a label is identified and an object identifier created, a search is done for the object identifier in the database. If the object identifier is not already in the database the object identifier is added to the database. As an example only, the database can be implemented using index tables and flat files, relational or object based database systems, naming and directory services, etc.

Once an object identifier is identified within a database, media content can be mapped to the object identifier. As noted previously, the media content can be in one or more formats including text, audio, graphics, digital image, and video. Multiple media content can be associated with the same object identifier within a database and can be stored in one or more locations. To remove errors in the indexing process, such as associating media content with the wrong object identifier and, accordingly, the wrong object, when a new object is identified in the authoring mode, the system can create a new entry in the database and immediately prompt the user to author/identify media content that is to be associated with the object identifier. This coincident object identifier creation and authoring/identifying allows media content and object identifier binding to occur nearly instantaneously.

The advantage of the labeling and media content scheme described above is particularly seen in practical applications such as, for example, home cataloging situations where picture albums, CD collections, book collections, articles, boxes, etc. are organized. If also finds use in commercial contexts, both small and large, where a vendor might wish to provide information on objects being sold. An example of a small commercial context usage is an antiques vendor labeling his articles and/or parts of articles and associating media content therewith that might explain historical significance. In this regard, the objects can be quickly labeled in any order and have content quickly and easily associated therewith. In a larger commercial context, a vendor can author daily promotions and sales information by scanning a label associated with an object and associating media content describing the promotion and sales information with the object.

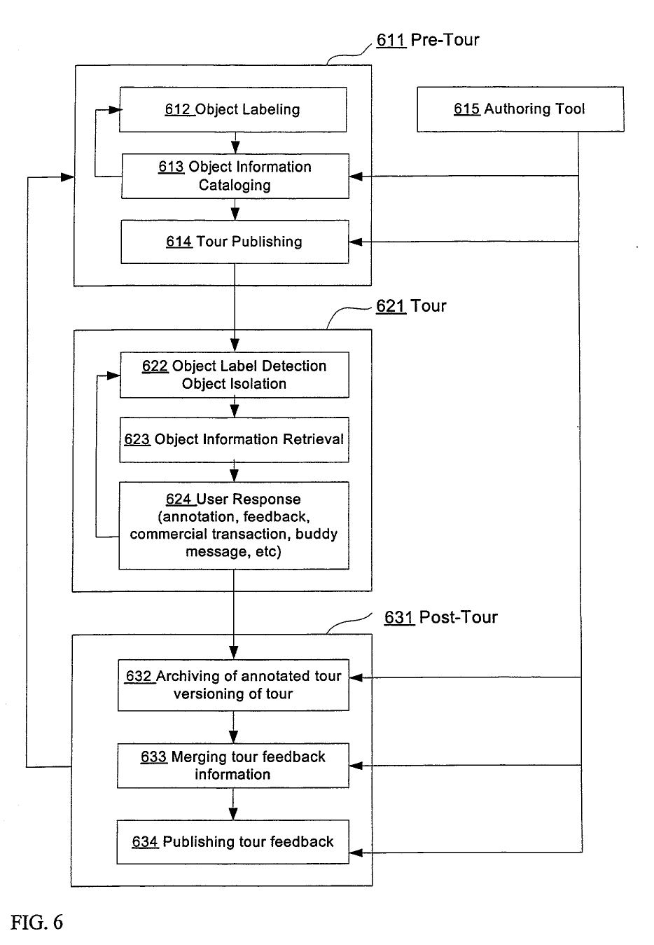

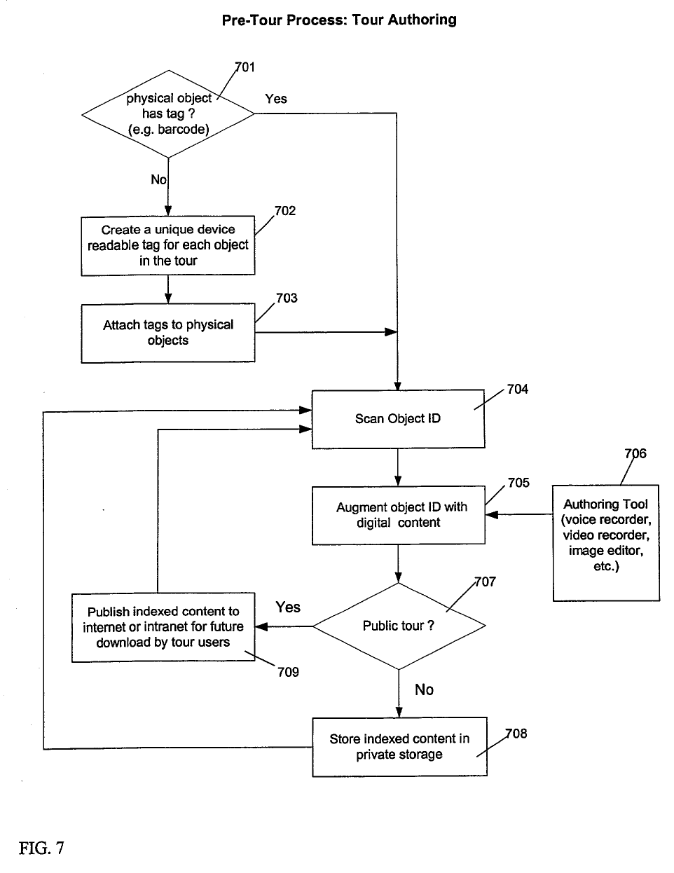

While the database can be created using a host computer, it is preferred that the database be created using the mobile personal device 207. To this end, the mobile personal device allows the user to read the label and author the content that is to be associated with the read label. The mobile personal device 207, or the server side components, will then automatically map the content and the created object identifier to each other within the database. It will be appreciated that this makes the binding of coordinates particularly easy since the content author can directly create content to be mapped to the coordinate at that very location. A particular example of this would be a real estate agent creating a tour of a home while touring the home. It would also be possible for a potential homebuyer to author feedback which can also be mapped to the coordinates as the potential homebuyer tours the home. The process for authoring a tour is generally illustrated as steps 612-614 in FIG. 6 (pre-tour 611 being performed with the assistance of an authoring tool 615) and steps 701-709 in FIG. 7. Furthermore, an author can choose to make some or all of his tours private. A private tour does not mean that it cannot be stored on a server. Public tours are open to public, possibly at a price. It is left to the discretion of the content creator.

Still further, browsed web pages can be aggregated into a tour since the browsing process creates an ordering of content and an index table with the links that were traversed during the browsing (it is also conceivable that all hyperlinks in the pages visited could be automatically added into the index table). The browsed content can then be augmented with annotations and feedback which are bound to indices accessed in this browsing sequence. Thus, playback of one or more tours or conventional web browsing can be treated as an authoring of a new tour that is a subset of the tours and web pages navigated in playback mode. This functionality is very useful to create a custom tour containing information extracted from multiple tours and conventional web pages.

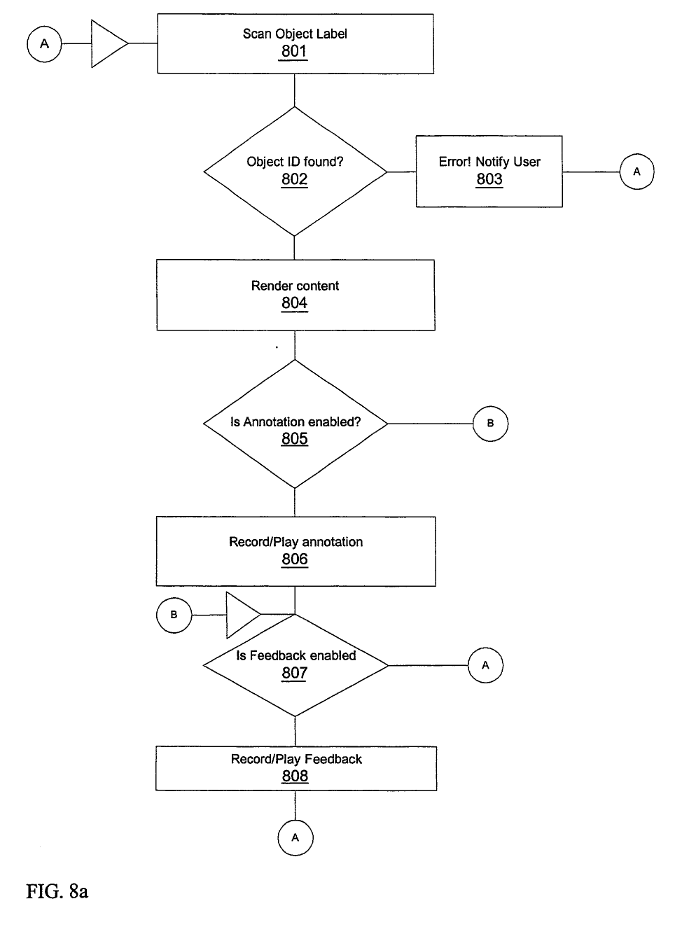

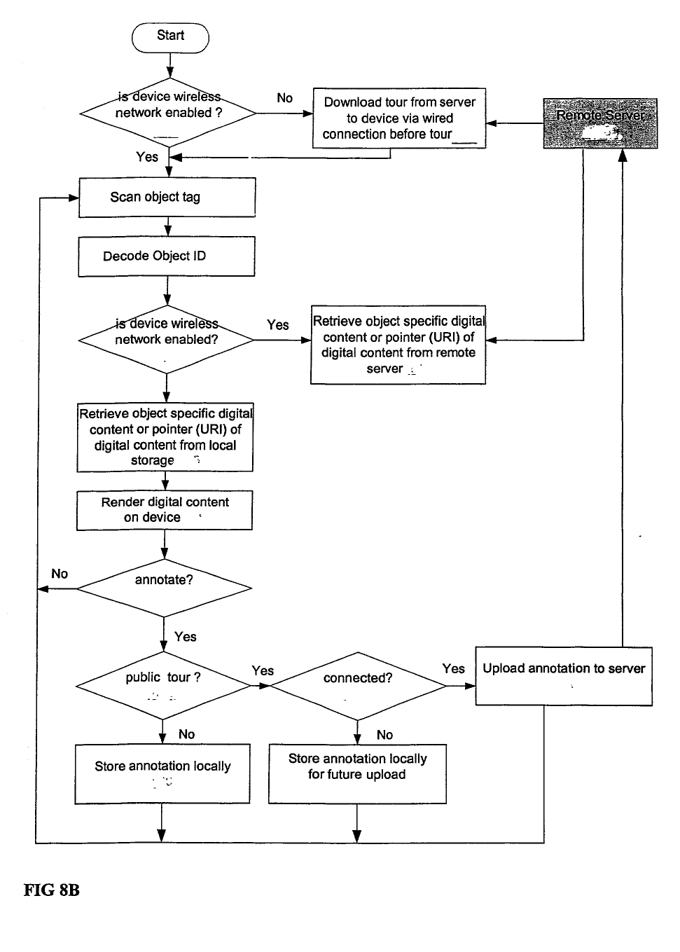

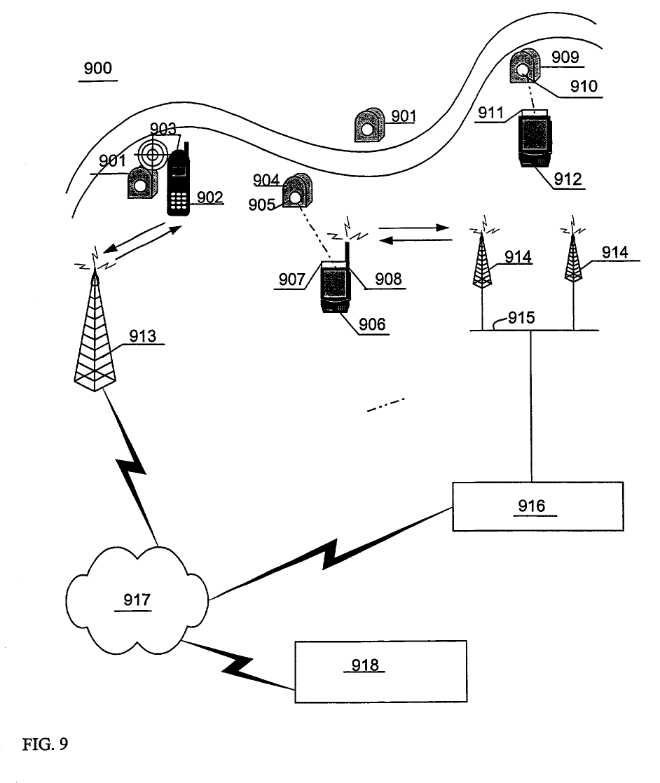

To playback media content that has been mapped to an object identifier within a database, the system determines the object identifier for a read label, searches for the object identifier in a database, retrieves the media content associated with the object identifier, and sequentially renders the media content on the personal mobile device 207. This is generally illustrated in FIG. 6 as steps 622-624 related to the tour process 621 and as steps 801-804 illustrated in FIG. 8. During the playback mode, it is preferred that, if the same media content is being indexed by the reading of multiple labels repetitious playback of the same content is avoided.

Label identification in the playback mode is virtually the same as the label identification in the authoring mode. While label identification initiates object creation in the authoring mode, label identification initiates label matching followed by media rendering (if the label has an object identifier) in the playback mode. Furthermore, in playback mode, in addition to manual label reading, label reading may be automatically initiated either by a location-aware wireless network, an RFID tag in the proximity of the device, or by an internal clock trigger system. As noted, the outcome of the label identification process is an object identifier that can be used for indexing media content.

Once a match is found in a database for the object identifier, media content bound to that object identifier can be sequentially rendered, provided that the media content is supported by the mobile personal device 207. Playback of media content can be triggered in three ways, namely, by a user manually initiating the label identification, by the automatic reading of a label, or by a sequential presentation, e.g., a linear traversal of elements of a tour. The first two method of triggering playback enable the tour to provide a user experience somewhat similar to having a human guide; the manual triggering being equivalent to the user asking a particular question and the automatic triggering being equivalent to an ongoing commentary. Thus, the tour provides a richer user experience than the one provided by a human guide since these two methods of playback serve as two logical channels containing multiple media streams. To ensure that two channels do not conflict, one channel can be designated as a background channel which has a lower rendering priority than the other. When a background feed is being inhibited as a function of its lower priority, an application may choose to provide a user with an interface cue (e.g., audio, graphics, text, or video) that indicates a background feed is available.

It is possible during the label identification process that a label detected in the physical world does not have a corresponding object identifier in a database. In this case, the tour may be authored to provide alternate index lookup schemes to find an unmatched index such as, for example, an index search in select URLs. If the index is found, then that index can be added to the tour's database and the content can then become part of the ordered elements of the tour.

During the playback mode, generally illustrated in FIG. 8b, a user may be given the ability to annotate content as particularly illustrated as steps 805 and 806 in FIG. 8a. The media for accepting annotations depends upon the capabilities of the device that accepts the annotations. When multiple objects qualify for annotation, a user should be prompted to choose among these multiple objects. An example of this may arise when a user stopped playback of a manually scanned object and the location of the object happens to coincide with a coordinate for which content is available. Feedback, illustrated in steps 807 and 808 of FIG. 8a, could also be made an interactive process. Still further, the tour may also support the notion of a live-agent connection facility which enables the user to connect directly to a human agent to initiate a transaction. This is particularly useful when the mobile personal device 207 is embodied in a cellular telephone. The user may initiate an electronic e-commerce transaction using the established connection. During the tour the user may send asynchronous messages to other users of the communication network. This message can be a voice mail message left in a secure access protected voice mail box picked up by the recipient of the message from the mail box (“poste restante”). The message can be a reminder alert to the sender herself delivered at a future time. The system may apply transformations on the message such as, by way of example, converting a voicemail to text and post it on a web site, or create an SMS message, or email representation of the message and deliver it to the addressee.

As noted above, the authoring and playback of a tour imposes no constraints on the physical location of a tour or its contents, i.e., it could be locally resident on the mobile personal device or remotely resident on a server. When remotely located, the tour can be accessible by one of the several wireless access methods such as, for example, WPAN (Wireless Personal Area Network), WLAN (Wireless Local Area Network), and WWAN (Wireless Wide Area Network). Furthermore, the media content could be pre-fetched, downloaded on demand, streamed, etc. as is appropriate for the particular application.

Feedback and annotation provided in the context of a tour, the creation of which is generally depicted as 631 in FIG. 6 including steps 632-634, could also be resident in any physical location. Since feedback/annotation is bound to object identifiers that provide the context for the annotation/feedback, it is also possible to create a tour subset of an original tour that contains only those elements which have annotation and feedback. This would be very useful if the user is interested not in recapitulating the entire tour but only those parts that were annotated or for which feedback was provided. To this end, a tour application running on a PDA, for example, can easily send the annotations and feedback to an appropriate destination as an email attachment for rendering by a party of interest as a new tour.

The following description and Table 1 and Table 2 set forth below generally describe applications in which the tour may be used.

TABLE 1
Application categories

| Type | Description of Application | Labeling scheme |
|---|---|---|
| 1 | Physical label-based applications | barcode, RFID, IR, text |
| | | strings, speech-to-text |
| | | strings, timestamp |
| 2 | Location-based applications | Coordinates, text strings, |
| | | speech-to-text strings, |
| | | timestamp |
| 3 | Timestamp based applications | timestamp |
| 4 | Linear ordering based applications | no label, application |
| | | depends on linear ordering |
| | | of tour content. |

TABLE 2
Examples of Applications

| | | | | Device | | | |
|---|---|---|---|---|---|---|---|
| | Application | Application | Labeling | Purpose | | | Server |
| # | Name | Description | scheme | Built | PDA | Phone | Support |
| 1 | My First | Child's voice | Time-stamp | X | | | Optional - |
| | Words | cataloging while | | | | | needed only if |
| | (Type 3) | child is learning | | | | | device has |
| | | to speak. Parent | | | | | network |
| | | can annotate | | | | | connectivity |
| | | child's utterances | | | | | |
| 2 | Childs | Childs label based | Hand-written | X | | | No |
| | learning | learning device. | labels | | | | |
| | device | Objects in the | (numbering) | | | | |
| | (Type 1) | house are tagged | or Barcode | | | | |
| | | by parent. Child | | | | | |
| | | identifies the | | | | | |
| | | distinctive tags on | | | | | |
| | | object and scans | | | | | |
| | | them to get an | | | | | |
| | | audio feedback. | | | | | |
| | | This device can | | | | | |
| | | also he used to | | | | | |
| | | scan annotated | | | | | |
| | | books with | | | | | |
| | | embedded tags | | | | | |
| 3 | Travelers | Label objects and | Hand-written | X | X | X | Only for |
| | Language | record name of | labels | | | | phone |
| | Learning | object in a foreign | (numbering) | | | | |
| | Tool. | language | or Barcode | | | | |
| | (Type 1) | | | | | | |
| 4 | Picture | Album | Hand-written | X | X | X | Only for |
| | album | cataloging, home | labels | | | | phone |
| | annotation | objects cataloging | (numbering) | | | | |
| | (Type 1) | | or Barcode | | | | |
| 5 | Class Lecture | When professor | Hand-written | X | X | X | Only for |
| | Annotation | uses a printed | labels | | | | phone |
| | (Type 1) | book as the | (numbering) | | | | |
| | | reference for his | or Barcode | | | | |
| | | lectures, his | | | | | |
| | | lecture can be | | | | | |
| | | spliced by the | | | | | |
| | | student and he | | | | | |
| | | can correlate the | | | | | |
| | | page of the book | | | | | |
| | | with the | | | | | |
| | | appropriate | | | | | |
| | | annotation from | | | | | |
| | | the lecturer. | | | | | |
| 6 | Package | Useful for | Handwritten | X | X | X | Only for |
| | Annotation, | managing a | labels | | | | phone |
| | Cataloging | move, a | (numbering) | | | | |
| | Private | collectors dream | or Barcode | | | | |
| | Collectibles | for cataloging | | | | | |
| | (DVD, CD, | possessions. | | | | | |
| | books, etc) | | | | | | |
| | (Type 1) | | | | | | |
| 7 | Focus | Wine tasting, | Handwritten | X | X | X | Only for |
| | Groups, | product rating for | labels | | | | phone |
| | Marketing | consumer reports, | (numbering) | | | | |
| | Information | etc. | or Barcode | | | | |
| | Collection, | | | | | | |
| | Product | | | | | | |
| | Rating Tool | | | | | | |
| | (Type 1) | | | | | | |
| 8 | Shopping | Record and | Barcode, | X | X | X | Only for |
| | List | playback grocery | Handwritten | | | | phone |
| | (Type 1) | shopping list or | labels | | | | |
| | | other to-do list | | | | | |
| 9 | Personal | Seller labels | Handwritten | X | X | X | Only for |
| | Retail | objects, authors | labels | | | | phone |
| | Applications | content, buyer | (numbering) | | | | |
| | Art & Crafts | plays back | or Barcode | | | | |
| | and Antique | content | | | | | |
| | Shows, | | | | | | |
| | Auctions, | car showroom - | | | | | |
| | Art Galleries | label parts of car | | | | | |
| | (Type 1) | to explain | | | | | |
| | | features of the | | | | | |
| | | product | | | | | |
| 10 | Networking | Attendees wear | Handwritten | | X | X | Only for |
| | Party, | device readable | labels, | | | | phone |
| | Singles Party | badges, each | Barcode, | | | | |
| | (Type 1) | person can | IR tags | | | | |
| | | publish a short | | | | | |
| | | introduction of | | | | | |
| | | her/himself | | | | | |
| 11 | Talking | Directions, store | Barcode, | | X | X | Only for |
| | Malls, | directory | RFID | | | | phone |
| | Outlets, | information, | Coordinates | | | | |
| | Stores, | coupons, specials, | | | | | |
| | Retail | product reviews, | | | | | |
| | (Type 1 and | price comparison, | | | | | |
| | Type 2) | Guide to | | | | | |
| | | shopping malls, | | | | | |
| | | outlets, retail | | | | | |
| | | stores, etc. | | | | | |
| 12 | Poste | The service offers | Primary label | | X | X | Yes |
| | Restante | a voice and web | can be | | | | |
| | (Type 1, | accessible | location, | | | | |
| | Type 2, Type | personal | barcode, etc. | | | | |
| | 3, and Type | communication | Secondary | | | | |
| | 4) | portal on a server | label: | | | | |
| | | for people to | timestamp | | | | |
| | | leave tours for | | | | | |
| | | others to use. | | | | | |
| 13 | Talking | Children can go | Coordinates | | X | X | Only for |
| | Treasures | treasure hunting | and physical | | | | phone |
| | Museums, | in science centers | labels | | | | |
| | Galleries, | and the more | (barcode, | | | | |
| | Exhibitions, | talking treasures | RFID, IR, | | | | |
| | Trade | they find and | etc) | | | | |
| | Shows, | learn they are | | | | | |
| | Science | rewarded. | | | | | |
| | Centers | Note: Talking | | | | | |
| | (Type 1 and | Treasures tour is | | | | | |
| | Type 2) | not limited to | | | | | |
| | | audio, it may | | | | | |
| | | include any | | | | | |
| | | multimedia | | | | | |
| | | content | | | | | |
| 14 | Talking | Tour of famous | Coordinates, | | X | X | Only for |
| | Graves | cemeteries | RFID, | | | | phone |
| | (Type 2 and | (Arlington, Pere | text strings, | | | | |
| | Type 1) | LaChaise | speech-to- | | | | |
| | | Cemetery, | text | | | | |
| | | Hollywood | | | | | |
| | | forever cemetery, | | | | | |
| | | ete) | | | | | |
| | | Find-A-Grave | | | | | |
| | | biographic tours | | | | | |
| | | of celebrities | | | | | |
| | | (Graceland) | | | | | |
| 15 | Talking | National park | Coordinates. | | X | X | Only for |
| | Trails | nature trails. | RFID, | | | | phone |
| | (Type 2 and | (Grand Canyon, | text strings, | | | | |
| | Type 1) | etc) | speech-to- | | | | |
| | | | text | | | | |
| 16 | Talking | Tour Guides for | Coordinates, | | X | X | Only for |
| | Cities | cities and | RFID, | | | | phone |
| | (Type 2 and | buildings, | text strings, | | | | |
| | Type 1) | Freedom Trail in | speech-to- | | | | |
| | | Boston, The Mall | text | | | | |
| | | in Washington | | | | | |
| | | D.C., | | | | | |
| | | interiors of | | | | | |
| | | historic buildings | | | | | |
| | | churches, town | | | | | |
| | | halls, historic | | | | | |
| | | ships, etc | | | | | |
| 17 | Voice Trails | Waypoint | Coordinates | | X | X | Yes |
| | (Type 2) | annotations. | | | | | |
| | | People can share | | | | | |
| | | their experiences, | | | | | |
| | | opinions. | | | | | |
| | | Multiple authors | | | | | |
| | | can author | | | | | |
| | | content for the | | | | | |
| | | same label. The | | | | | |
| | | individual | | | | | |
| | | experiences are | | | | | |
| | | aggregated on a | | | | | |
| | | web site hosted | | | | | |
| | | on the internet | | | | | |
| | | into a shared tour | | | | | |
| | | of the | | | | | |
| | | community. | | | | | |
| | | Authors can | | | | | |
| | | upload to the tour | | | | | |
| | | host site and users | | | | | |
| | | can download to | | | | | |
| | | their mobile | | | | | |
| | | apparatus. | | | | | |
| | | Example all | | | | | |
| | | people who are | | | | | |
| | | walking the | | | | | |
| | | Appalachian Trail | | | | | |
| | | record their diary | | | | | |

Examples of applications are shown in Table 2, applications 1-9. For example, the system and method can be used for cataloging the early words of a child (Table 2, application 1). All parents can fondly recall at least one memory of their child's first utterance of a particular word/sentence. They are also painfully aware that it is so hard to capture those invaluable moments when the child makes those precious first utterances of a word/sentence (by the time parent runs off to fetch an audio/video recorder, the child's attention has shifted to something new and it is virtually impossible to get the child to say it again). Also the charm of capturing the first utterance is never the same as the subsequent utterance of the same word/sentence.

To solve these problems, the apparatus described herein can be used to create a tour with a voice-activated recorder which records audio and catalogs it using a timestamp as the index. The system can be used to aggregate words/sentences spoken separately for each day thus serving as a chronicle of the child's learning process. The system can also be used to permit annotations of the authored content, the authored content being the child's voice. For example, a parent can annotate a particular word/sentence utterance of a child with the context in which it was uttered making the tour an invaluable chronicle of the child's language learning process.

The system can also be used to allow the parent to author multiple separate sentences in the parents own voice. This sentence would be randomly chosen and played when the child speaks to thereby encourage the child to speak more. The authored tour and the annotation can be retrieved from the device for safe-keeping. Though digital voice recorders of different flavors abound in the market, none of them match the key capabilities of the present invention which makes it best suited for this application. In particular, these devices do not support annotations of already recorded content nor authoring by a parent which is subsequently played as responses to the child speech which can serve to encourage the child to speak more.

The above-described functionality of the system can be integrated into child monitoring devices existing in the market today, such as the “First Years” brand child monitor. Specifically the capability of this embodiment may be integrated into the transmitter component of the device. It will be appreciated that the receiver is not an ideal place for integration since it receives other ambient RF signals in addition to the signals transmitted by the transmitter.

In still another application, the system and method can be used as a child's learning toy (Table 2, application 2). Preferably, in this application, a child-shield that selectively masks certain apparatus controls can be placed on the personal mobile device 207. The “toy usage” of the apparatus highlights ease of content authoring and playback. In an example of this application, a mother labels objects in her home (or even labeling parts of a book) using barcode or RFID labels and records information in her own voice about those objects. The child then scans the label and listens to the audio message recorded by the mother. The mother could hide the label in objects around the house, making the child go in search of the labels, find them and listen to the mother's recording. It would thus serve the purpose of a treasure hunt.

Yet another usage of the system and method is as a foreign language learning tool for an adult (Table 2, application 3). When an object is scanned, the personal mobile device would play the name of that object in a particular language. Still further, the system and method can be used to implement a digital audio player where the indexing serves as a play list.

In its usage as a cataloging apparatus, the subject system and method can be used to catalog picture albums, books, CD, DVD collections, boxes during a move to a new apartment, etc. (Table 2, applications 4, 5, 6). The system can rely on a simple labeling scheme. The device can be supplemented with pre-printed, self-adhesive barcode labels (similar to those used as postal address labels). In this regard, a user might label the pictures, etc. in any desired order with a unique number. Coincident with the labeling, or subsequent to the labeling process, the user may author content for a particular index and manually preserve the association between the index value of a picture, etc. and the authored content. Should the mobile personal device 207 include a barcode scanner, the barcode scanner can assist in maintaining the correspondence between the picture, etc. and the authored content by supporting coincident authoring of content with the label detection. In this implementation the labeling scheme would be done using any barcode-encoding scheme that can be recognized by the barcode reader. In this scenario the author of the tour and the playback of the tour might be the same person or different persons.

The mobile personal device 207 can also provide interface controls for providing digital text input, e.g., an ordinal position of content in a tour. It may have an optional display that displays the index of the current content selection. Interface controls can provide an accelerated navigation of displayed indices by a press-and-hold of index navigation buttons thus enabling the device to quickly reach a desired index. This is advantageous since the index value may be large making it cumbersome to select a large index in the absence of keyboard input. The mobile personal device 207 could also be adapted to remember the last accessed index when the device is powered down to increase the speed of access if the same tour is later continued. In further embodiments, the personal mobile device 207 can have a mode selector that allows read only playback of content. This avoids accidental overwrite of recorded content.

When the system and method is used as a “personal cataloger/language learning/audio player,” then the tour authoring and playback apparatus 207 need only be provided with object scanning capability as it is intended for sedentary usage and, therefore, need not support coordinate-based labeling. This personal mobile device 207 can be adapted to allow multiple tours to be authored and resident on the device at the same time.

The system and method can also serve as a memory apparatus, for example, assisting in the creation of a shopping list and tracking the objects purchased while shopping to thereby serve as an automated shopping checklist (Table 2, application 8). To this end, the system can maintain a master list of object identifiers with a brief description of these objects created in the authoring mode.

Table 2, applications 10-17 are examples of tours particularly targeted to cellular phones and handheld devices (PDA). The system can be used as a tour authoring and playback device that implements all forms of object labeling and indexing mentioned earlier, e.g., text strings, speech-to-text, barcode, RFID, IR, location coordinate, and timestamp. All of the tours may include any multimedia content and are not limited to audio. One application of such a “tourist-guide” is a tourist landing at an airport and using the system to obtain information about locations, historical sites, and indoor objects. Another application is a sightseeing walking tour (Table 2, application 16) of a historic town where an outdoor street tour is intermixed with visiting interiors of buildings along the way. In this application, a variety of labeling methods may be used as depicted on FIG. 5. It can be appreciated that multi-lingual versions of the tour may be bound to the same labels. It can be appreciated that in a city where the visitor is unable to read street signs due to language barriers (such as Westerner cannot read Japanese letters), or a blind person, still would be able to receive the same information as someone proficient in the local language. Another application of the apparatus is a user going to a large shopping mall, and using the apparatus to navigate the mall, and to find information on items in a store.

“Poste Restante” service (Table 2, application 12) offers a voice and web accessible personal communication portal (multimedia mailbox) on a server for people to leave tours for others to use. The owner and authorized visitors access the personal portal (multimedia mailbox) via a toll-free telephone number or via a web browser. The owner can leave reminders to herself (where did I parked my car?) or share tours (such as “My First Words”) with friends and family or even strangers.

In yet another application the tour is built by multiple authors and the tour represents the shared experiences of a community (Table 2, application 17). The tour is a collection of annotated waypoints. The tour is hosted at an Internet web site. Authors can upload label-content pairs and add them to the tour. Users can download the tour to their mobile apparatuses. Authors and users can be the same or different persons. An example of such a tour can be hikers on the Appalachian Trail that record location coordinate label and personal diary content pairs and upload the pairs to the tour's web site. Visitors of the web site in turn are able to download the tour to their personal mobile apparatuses.

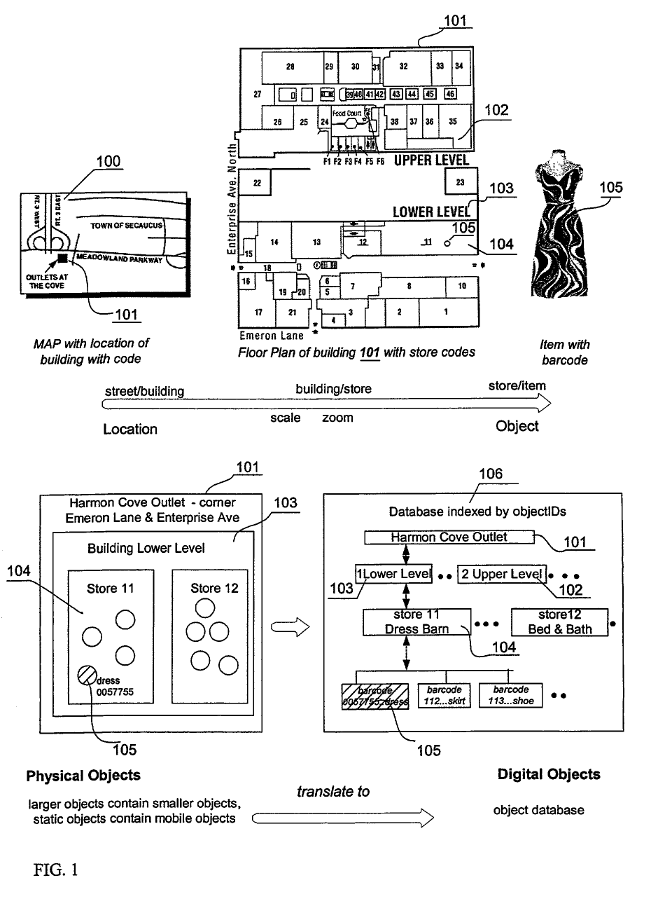

By way of more specific examples, FIG. 1 illustrates an embodiment of the mobile guide system where the application is a tour of a shopping center. The figure illustrates two aspects of the system, namely, a method of mapping physical world locations and objects into digitally stored object identifiers stored in a database and the use of uniform object identifiers for locations, buildings and individual objects in the same system. The tour starts with the visitor approaching the outlet center. Map 100 depicts the location and directions to center 101 which can be presented to the user as a result of reading a “label-in-the-air.” The object identifier for the outlet center is derived from its location coordinates.

Similar information can be presented to the user as the user navigates through the coordinates within building 101 which contains upper level 102 and lower level 103. Each level contains stores. On lower level 103 there is store 104 (Store 11 in the local directory). Store 104 contains dress 105 that can be labeled with a unique barcode which the user can read to receive information about the dress. Thus, the visitor can browse this physical world equipped with a handheld mobile device 207 and the tour is a “zoom in” from large static objects to small mobile objects as the visitor makes her way from street, to building, to floor, to store, finally to the dress. The larger static objects contain the smaller mobile objects. This containment property of spaces and objects aids the system in narrowing down the location of the visitor inside the building. For large static objects such as streets and buildings the system derives an object identifier from the geographical position of the object. Once the visitor turns her attention to small mobile objects such as a dress, then the longitude and latitude of the visitor is no longer relevant. Therefore the system derives the object identifier for small mobile objects from machine readable tags, such as commercial barcodes.

To facilitate the tour, an example of the handheld device can be an Ericsson GSM telephone model R520, R320, T20, etc. with a barcode scanner attachment. In another example, the shopping center can be wired with 802.11 or Bluetooth Wireless Local Area network (WLAN) and the visitor can use a PDA with a WLAN network interface card (NIC) to communicate with the local wireless network. The system can retrieve additional information about the visitor's location (“label-in-the-air”) by tracking which wireless WLAN access point the visitor's NIC connects to and by approximating the distance of the NIC from the access point based on RF signal strength. Additional information may be generated to help to determine the NICs location by logging the movement of the NIC using timestamps and comparing the last know position of the NIC with its current approximated position.

In another specific example, illustrated in FIG. 9, the application is a guided tour of cemetery 900. Visitors walk along the road among the graves 901 and try to find graves of famous people or loved ones. The labels marking the graves trigger the playback of the content bound to that label, and the visitor with the mobile device can hear the voice of the person honored with the tomb stone, see the person's image on the display of a PDA, etc. creating a special user experience. It can be appreciated that there is an intangible benefit when a place or an object (the tomb stone in this case), or a person long passed, can directly “talk” to the visitor. It can be a much more cathartic experience than a presentation by a “middle-man” such as a live tour guide.

The figure illustrates three different devices with different capabilities used to take the same tour. The three devices are: (1) cellular telephone with local GPS receiver, or network based GPS server; (2) PDA with WLAN or WWAN modem connection; and (3) PDA without network connection. In more details, the first visitor uses a cellular-phone 902 equipped with a built-in GPS positioning receiver 903. The phone decodes the GPS coordinates longitude/latitude and sends the coordinates through cellular base-station 913 to a remote server platform 918. Server platform 918 receives the request, transforms the location coordinates into an object identifier, looks up the content associated with the object identifier, and sends back the information about nearby grave 901 to phone handset 902. Alternatively the phone does not have built in GPS receiver, and instead it retrieves its location from a remote location server. Additionally the visitor may say the name of the person on the tomb and other identifying information such as date of birth or death. The server converts speech to text and uses the text string as label to look up tour information. Depending on the capabilities of the phone, the information can be a voice response or a display of additional graphical information in a wireless browser that is running on the phone. Server platform 918 may support some or all of the following protocols: Voice/IVR/VoiceXML, HTTP, WAP Gateway, SMS messaging, I-Mode, GPRS, and other wireless data communication protocols known in the arts.

A second visitor uses a pocket PC 906 such as, for example, a Compaq iPAQ, with dual communication slots wherein slot 907 contains an RFID reader and slot 908 houses either a 802.11 WLAN Network Interface card (NIC) or a Bluetooth NIC. A nearby grave 904 has RFID tag 905 mounted on it. RFID reader 907 reads RFID tag 905, and transforms the RFID tag information to a universal object identifier. Alternatively if the PDA does not have an RFID reader, the visitor may enter the name on the grave as a label. Pocket PC 906 connects to a Wireless Local Area Network (WLAN) Access Point 914 using a WLAN NIC (Network Interface Card) 908. Wireless Access point 914 connects through local area network 915 to local content distribution server platform 916. Alternatively, the WLAN NIC can be substituted with a CDPD wireless modem card or other WAN network card that enables the PDA to connect to a cellular data network.

A third visitor uses a Handspring Visor 912 with a Springboard module RFID reader 911. A nearby grave 909 has RFID tag 910 mounted on it. RFID reader 911 reads RFID tag 910 and transforms the RFID tag information to a universal object identifier. As an alternative to RFID, the visitor can enter the name on the grave as label. Visor PDA 912 does not have a network connection. It stores object identifiers and content locally on the device.

From the foregoing, it will be appreciated that the described system and method bridges the world of object-based information retrieval and location-based information retrieval to thereby provide a seamless transition between these two application domains. In particular, the described system provides, among others, the following advantages not found in prior systems:

(1) Using the Internet as an easily accessible vast information resource, off-the-shelf multi-media capable portable handheld devices and ubiquitous wireless networks, the present innovation provides an open, interactive guide system. The user is an active, interactive participant of the guided tour, a creator and supplier as much as he/she is a consumer. Applications are only limited by imagination—ranging from educational toy, treasure hunt in a science center, bargain hunt in a shopping mall, touring historic cities or famous cemeteries, attending networking parties where people wear machine readable badges, etc. In all of these applications, the user, with the aid of the present invention, is able to personalize, annotate the tour with his/her own impressions, share feedback with other users, initiate an interaction or transaction with other humans or machines.

a. The individual may create his/her own object tags, and label the objects around her.

b. The author of a tour and the user of a tour (supplier and consumer) might be the same person(s) or different person(s).

c. A “private tour” can be easily published to the Internet or to a local community, and made “public” for other people to use, contribute, exchange or sell.

d. The tour is no longer a closed, finished product,—it can be personalized, shared, co-authored by people who have never met in person

e. Users may use their personal portable handheld devices, instead of renting specialized proprietary devices from institutions, and download only the software and content from the internet or local area networks.

f. Users and service providers have access to authoring tools to author and publish multimedia content including streaming video and audio.

g. The system provides system and method, to author and publish a tour, but the system does not restrict the content of the tour.

(2) Prior systems treat location-based services and object labeling as two separate techniques. The current invention treats these two aspects of the physical world as labeled objects of different scales. Small mobile objects and large static objects (such as buildings a.k.a. locations) are both modeled with the same data structure, and as labeled objects. The current invention can naturally accommodate physical objects of all scales, and relationships among plurality of physical objects around us.

(3) The system can be used both indoors and outdoors.

(4) Tour content can be authored in different media types. The tour presentation depends on the capabilities of the device (audio only, text only, hypertext, multimedia, streaming video and audio etc) and would do appropriate media transformations and filtering. A tour would work both with and without network access. The user can download the tour content before the tour, and store it on a portable handheld device, or access the tour content dynamically via a wireless network.

(5) The system takes advantage of both existing object tags (barcodes, RFID, Infrared tags) and specialized tags made for a specific tour.

(6) The benefit of the logical aggregation of related content into a tour is clearly apparent, not just in the multitude of commercial applications, but also in the multitude of personal usage scenarios, such as an audio annotated album, a chronological repository of a child's early utterances, or a tour containing a mothers' annotation of her old home and the articles she left behind bequeathed to her children. The tour serves, in these cases, as an invaluable time warp triggering recall of fond memories that enrich our lives. It also plays the important role of immortalizing humans with a media rich snapshot of their lives.

It will be appreciated by those skilled in the art that various modifications and alternatives to the specific embodiments described could be developed in light of the overall teachings of the disclosure. Accordingly, the particular arrangement disclosed is meant to be illustrative only and not limiting as to the scope of the invention. Rather, the invention is to be given the full breadth of the appended claims and any equivalents thereof.

What is claimed is:

1. A method for authoring information relevant to a physical world, comprising:
detecting with an authoring device a first label associated with a first object; and
triggering, in response to detecting, a system for authoring content;
wherein the content is to be unambiguously bound to the first object and is to be rendered on a playback device during detection of the first label.

2. The method as recited in claim 1, wherein the system for authoring content is resident on the authoring device.

3. The method as recited in claim 1, wherein the authoring device and the playback device are integrated within a single apparatus.

4. The method as recited in claim 1, wherein the label is selected from a group consisting of a barcode label, a coordinate, a RFID tag, an IR tag, a time stamp, a text string, and a speech to text string.

5. The method as recited in claim 1, wherein the content is selected from a group consisting of audio, text, image, and video.

6. The method as recited in claim 1, wherein the content is a link to a live agent.

7. The method as recited in claim 1, further comprising the steps of detecting a second label associated with a second object; triggering, in response to detecting, the system for authoring content which is unambiguously bound to the second object; and aggregating the content bound to the first object and the second object into a tour.

8. The method as recited in claim 1, further comprising the step of detecting a second label associated with the first object and normalizing the first label and the second label such that the content bound to the first object can rendered during detection of either the first or second label in the playback mode.

9. The method as recited in claim 1, further comprising the step of storing the content in non-volatile memory resident in the apparatus.

10. The method as recited in claim 1, further comprising the step of uploading the content to a remote server.

11. The method as recited in claim 10, wherein the step of uploading is performed via a wireless network.

12. The method as recited in claim 10, wherein the step of uploading is performed via a wired network.

13. A computer-readable media having instructions for authoring information relevant to a physical world, the instructions performing steps comprising:
detecting a first label associated with a first object; and
triggering, in response to detecting, a system for authoring content to be unambiguously bound to the first object;
wherein the content is to be rendered during detection of the first label by a device in a playback mode.

14. The computer-readable media as recited in claim 13, wherein the instructions perform the further steps of detecting a second label associated with a second object; triggering, in response to detecting, a system for authoring content to be unambiguously bound to the second object; and aggregating the content bound to the first object and the second object into a tour.

15. The computer-readable media as recited in claim 14, wherein the instructions perform the further step of detecting a second label associated with the first object and normalizing the first label and the second label such that the content can rendered during detection of either the first or second label by the device in the playback mode.

16. A computer-readable media having instructions for authoring content to be associated with objects in a physical world, the instructions performing steps comprising:
normalizing a read object label associated with an object into an object identifier;
placing the object identifier into a database;
accepting content to be rendered when the object label is read in a playback mode; and
binding the content to the object identifier in the database.

17. The computer-readable media as recited in claim 16, wherein the instructions allow a plurality of different label types to be normalized to one object identifier.

18. A method for providing information relevant to a physical world, comprising:
detecting with a device a label associated with an object;
normalizing information contained in the detected label into an object identifier;
using the object identifier to search a database to find content bound to the object identifier; and
rendering the content.

19. The method as recited in claim 18, further comprising the step of retrieving the content bound to the object identifier from local memory in the apparatus.

20. The method as recited in claim 18, further comprising the step of retrieving the content bound to the object identifier from a remote server.

21. The method as recited in claim 18, wherein the content is selected from a group consisting of audio, text, image, and video.

23. The method as recited in claim 18, wherein the label is selected from a group consisting of a barcode, a coordinate, an IR tag, a RFID tag, a timestamp, a text string, and a speech to text string.

24. The method as recited in claim 18, wherein the content is a connection to a live agent.

25. The method as recited in claim 18, further comprising the step of determining the current time and comparing the current time to the timestamp before rendering the content.

26. The method as recited in claim 18, wherein the step of rendering the content comprises streaming the content from a remote server.

27. The method as recited in claim 18, further comprising the steps of accepting annotations/feedback after the rendering of the content and binding the annotations/feedback to the object identifier.

28. The method as recited in claim 27, further comprising the step of storing the annotations/feedback in local memory.

29. The method as recited in claim 27, further comprising the step of storing the annotations/feedback in a remote memory.

30. A computer-readable media having instructions for providing information relevant to a physical world, the instructions performing steps comprising:
detecting a label associated with an object;
normalizing information contained in the detected label into an object identifier;
using the object identifier to search a database to find content bound to the object identifier; and
rendering the content.

31. The computer-readable media as recited in claim 30, wherein the content is selected from a group consisting of audio, text, and video.

32. A method for providing information relevant to a physical world, comprising:
storing an object identifier indicative of a plurality of read labels associated with an object into a database; and
using the database to bind content to the object identifier and, accordingly, the object;
whereby the content is renderable when any one of the plurality of labels is detected in a playback mode.

33. The method as recited in claim 32, wherein at least one of the plurality of labels is custom created.

34. The method as recited in claim 32, further comprising the step of attaching at least one of the plurality of labels to the object.

35. The method as recited in claim 32, wherein the plurality of labels is selected from a group consisting of a barcode label, a coordinate, a RFID tag, an IR tag, a time stamp, and a text string.

36. The method as recited in claim 32, further comprising the steps of detecting the plurality of labels.

37. A method for providing information relevant to a physical world, comprising:
associating one or more labels with each of a plurality of objects in a tour;
storing an object identifier indicative or the one or more labels associated with each of the plurality of object in the tour in a database;
authoring content relevant to each of the plurality of objects in the tour; and
binding the content to an object identifier in the database which corresponds to the relevant one of the plurality of objects in the tour whereby the content is renderable when the label is detected by a playback device without regard to the order in which the content was authored.

38. The method as recited in claim 37, wherein the labels are selected from a group consisting of coordinates, barcode labels, RFID tags, IR tags, timestamps, and text.

39. A system for authoring and retrieving selected digital multimedia information relevant to a physical world, comprising:
a plurality of machine readable labels relevant to the physical world;
an apparatus for detecting the machine readable labels and including programming for normalizing information contained in the detected label into an object identifier; and
a digital multimedia library accessible by the apparatus storing content indexed by the object identifiers.

40. The system as recited in claim 39, wherein the apparatus further comprises a system for authoring digital multimedia in response to detecting one of the plurality of labels which is to be stored within the digital multimedia library and unambiguously bound to the object identifier.

41. The system as recited in claim 40, wherein the apparatus further comprises a system for rendering digital multimedia in response to detecting one of the plurality of labels, the digital multimedia rendered being the content unambiguously bound to the object identifier associated with a detected label.

42. The system as recited in claim 41, wherein the digital multimedia library includes one or more of audio files, visual image files, text files, video files, XML files, hyperlink references, live agent connection links, programming code files, and configuration information files.

43. The system as recited in claim 41, wherein the apparatus comprises programming that renders digital multimedia as a function of output capabilities of the apparatus.

44. The system as recited in claim 39, wherein the physical world comprises labeled locations containing labeled mobile objects.

45. The system as recited in claim 44, wherein the labeled locations are used to determine proximity of the labeled mobile objects.

46. The system as recited in claim 39, wherein the digital multimedia library is stored on one or more computer servers external to the apparatus.

47. The system as recited in claim 46, wherein the digital multimedia library and the apparatus communicate via a wired network.

48. The system as recited in claim 46, wherein the digital multimedia library and the apparatus communicate via a wireless network.

49. The system as recited in claim 48, wherein the wireless network comprises a cellular telephone network.

50. The system as recited in claim 39, wherein the digital multimedia library resides on the apparatus.

51. The system as recited in claim 39, wherein the apparatus accesses the digital multimedia library via the Internet.

52. The system as recited in claim 39, wherein the apparatus accesses the digital multimedia library via a voice portal.

53. The system as recited in claim 39, wherein the apparatus accesses the digital multimedia library via a cellular telephone voice mailbox.

54. The system as recited in claim 39, wherein the digital multimedia is aggregated into a tour.

55. The system as recited in claim 39, wherein the digital multimedia is randomly accessible by the apparatus.

56. The system as recited in claim 39, wherein the digital multimedia is accessible by the apparatus in a sequential order.

57. The system as recited in claim 39, wherein the apparatus comprises a personal digital assistant.

58. The system as recited in claim 39, wherein the apparatus comprises a cellular telephone.

59. The system as recited in claim 39, wherein the apparatus comprises purpose built devices targeted to a specific application.

60. An apparatus for authoring information relevant to a physical world, comprising:
circuitry for detecting a label associated with an object; and
a system for authoring content to be unambiguously bound to the object as represented by the detected label which content is to be rendered during detection of the label in a playback mode.

61. The apparatus as recited in claim 60, wherein the circuitry comprises a barcode reader.

62. The apparatus as recited in claim 60, wherein the circuitry comprises an IR tag reader.

63. The apparatus as recited in claim 60, wherein the circuitry comprises a RFID tag reader.

64. The apparatus as recited in claim 60, wherein the circuitry comprises a keyboard for inputting textual information.

65. An apparatus for authoring and providing information relevant to a physical world, comprising:
circuitry for detecting a label associated with an object; and
programming for normalizing information contained in the detected label into an object identifier;
a system for authoring content in an authoring mode which content is to be unambiguously bound to the object identifier; and
a system for rendering content in a playback mode, the content rendered being the content unambiguously bound to the object identifier associated with a detected label.

66. The apparatus as recited in claim 65, further comprising a communications link for downloading authored content to a remote location and for retrieving content from the remote location for rendering.

67. The apparatus as recited in claim 65, further comprising a memory for storing the content.

68. The apparatus as recited in claim 65, wherein the circuitry comprises a barcode reader.

69. The apparatus as recited in claim 65, wherein the circuitry comprises an IR tag reader.

70. The apparatus as recited in claim 65, wherein the circuitry determines a coordinate location.

71. The apparatus as recited in claim 65, wherein the circuitry is a RFID tag reader.
